(19) United States
(12) Patent Application Publication
(10) Pub. No.: US 2011/0246902 A1
(43) Pub. Date: Oct. 6, 2011

(54) METHOD FOR PORTABLE PHONES TO CONTROL COMPUTERS

(76) Inventors: Tsung-Han TSAI, Taipei City (TW); Chen-Wei Su, Taipei City (TW); Chun-Ping Fang, Taipei (TW)

(21) Appl. No.: 12/752,446

(22) Filed: Apr. 1, 2010

(51) Int. Cl. G06F 3/048; H04M 3/00; G06F 15/16

(52) U.S. Cl. 715/740; 455/420

(57) ABSTRACT

The present invention relates to a method for portable phones to control computers, comprising the steps of: the portable phone entering into the mouse mode after connecting with the computer; controlling the computer to open game menus and select a game through the touch screen of the portable phone; the computer transmitting the set game interface to the portable phone to allow keys to be displayed on the touch screen. Once the game is started, if there is any touch upon the keys on the touch screen, the portable phone will transmit the signals of control keys that correspond to the internal settings of operation in the game. When the portable phone is moved or picks up voices, the G sensor or recording module will transmit signals of the sensed or acquired data to the computer, which will compare these signals with the gesture database, angle-acceleration database or voice recognition database of the voice recognition module, and will transmit the signals of control keys resulting from comparison to the game to make it act accordingly. In this way, the portable phone will be able to exercise wireless and touch-based control over games, achieving the purposes of improved convenience and reduced cost.

### BACKGROUND OF THE INVENTION

1. Field of the Invention

The present invention relates to a method for portable phones to control computers, more particularly, it relates to the method in which a touch screen of a portable phone is used to display key touches and a gravitational sensor (G sensor) is used to sense the direction and acceleration, or a recording module is utilized to pick up voices, followed by transfer of commands to a game directly or after comparison in a computer, in order to play games by using the portable phone to control computers.

2. Description of the Prior Art

With continuous development of new electronic products, continuous technological improvements in micro-electromechanical systems (MEMS) and wider use of these MEMS, more electronic components with different functions, e.g. digital cameras and G sensors, can be integrated into miniature electronic devices, such as mobile phones and PDA, etc. As touch screens become mature technologically and industrially, the production cost for touch screens also reduces, allowing touch screens to be integrated into more and more electronic devices. Thus, instead of installing keyboards that takes up more space, touch screens are only needed for operation of miniature electronic products that originally have very limited space in them. A miniaturized keyboard will not only make it inconvenient for users to press, it may even lead to the problem of wrong pressing by them. If some space for keyboards is saved in miniature electronic products, it will allow the size of their touch screens to be enlarged, thus increase the size of characters or pictures displayed in these screens and, as a result, make it easier for users to watch and operate.

Besides, firms are currently making improvements in miniature electronic products one after another to make these products capable of taking photos, playing music and connecting to Internet among other functions, and these products become more powerful to include more functions. Due to technological maturation in MEMS, G sensors are integrated additionally into miniature electronic devices one after another. Since users can watch pictures and images taken and stored by these electronic devices through the screens, they may change the angles at which the pictures and images are displayed on the screens by using the G sensor that is able to sense the angles at which users hold these devices in their hands. This will enable users to watch pictures and images on the screens from a right angle, whether the users hold the miniature electronic devices in a positive direction or not.

In addition, as versions of computer systems are updated continuously, system operators will improve system functions to make computers compatible with the latest products. Thanks to technological maturation in touch screens, computers have the function to support touch screen operation. Since touch screens allow users to operate computers for processing purposes (e.g. selecting, executing, copying, pasting, dragging and dropping, etc.) without using keyboards or mouses, the space for keyboards and mouses will be saved as a result. Moreover, the multi-touch function allows users to rotate, zoom in and zoom out and carry out other operations, making computers more convenient for use.

However, computers are partly used for playing games in present days, and keyboards and mouses are usually needed to play computer games. There are many kinds of computer games, and the set operating patterns may also be different in computer games of different kinds or different games of the same kinds. And multiple keys (e.g. 82, 104, or 105 keys, etc.) on keyboards can be used to make different key operation settings for different games. However, as it is very inconvenient to operate games of some kinds (such as aircrafts, fighting, car racing, etc.) by using keyboards and mouses, some firms have developed aircraft rods, main rods, steering wheel rods and other peripherals, which may require users to purchase many peripherals of different kinds additionally before they can operate computer games of different kinds conveniently.

Currently, there are still some problems with using keyboards, mouses and peripherals to play computer games in practical applications, for example:

(1) Commonly-used computers are equipped with keyboards and mouses. If users use aircraft rods, main rods, steering wheel rods and other peripherals for playing games, they need to spend a lot of money additionally in purchasing these peripherals, resulting in increased cost for playing computer games.

(2) There is limited space for displacement of touch due to miniature size of touch screens for mobile phones. For long-distance movement of cursors from left to right or from top to bottom in playing computer games, users need to move cursors on the touch screens of mobile phones several times to achieve long-distance movements. In practical applications, such way of operation is not only inconvenient but also time-consuming. Therefore, some firms try to solve this problem by amplifying signals to make the signals received on the touch screens roughly match the computer screens. Yet, because cases of fine movement of and clicking on keys, positions, characters or files are often seen during computer operations, if the approach of signal amplification is adopted, it will often generate problems of failing to move to desired positions and users need to make movements several times. Therefore, this approach still has disadvantages as it is inconvenient for use.

(3) Some other firms have developed the G sensor for mobile phones to control movement of the computer cursor by sensing users' gesture of holding the mobile phones and converting the sensed quantity of different angle and acceleration into movement quantity. In practical use, oblique displacement (e.g. oblique towards the top right direction, oblique towards the bottom left direction) often occurs, and accurate displacements of the cursor in the left and right directions can be identified since the cursor moves in both directions simultaneously. But the cursor cannot move smoothly in the upward and downward directions due to no movement in either direction, and users need to move the cursor repeatedly, making it very inconvenient for operation. To solve this problem, users need to achieve displacement of the cursor in one direction, and then change the direction of the cursor vertically for operating. Because it is different from peoples' habit of moving the cursor, such method may still generate the issues of wrong and inconvenient operations.

Thus, how to overcome the aforesaid problems and disadvantages of conventional methods for controlling computers by using mobile phones is just what the firms involved in this industry need urgently to research and improve.

### SUMMARY OF THE INVENTION

In view of the aforesaid problems and disadvantages, the inventor has collected related information, conducted assessments and taken considerations in many aspects, and based on his own experience of many years in this industry, has finally invented the method for portable phones to control computers following continuous trials and corrections.

The primary object of the present invention is to provide a portable phone for controlling computer for proper handling so as to have the advantage of achieving game control with a wireless approach. Besides, portable phones have been widely used and are therefore characterized by lower costs compared to touch screens, so users do not need to purchase touch display screens for computers additionally. By doing so, they can use the touch screens for portable phones to operate games and then achieve the purpose of improved convenience in operation and reduced costs.

The secondary object of the present invention is to display one or more keys of a game interface by using the portable phone, so that users can touch the screen to send signals of the keys on the keyboard to the game. They can also use the G sensor to sense movement of the portable phone, or use a recording module to acquire voices, and send the signals to a computer to compare with the angle and acceleration database, gesture database or voice recognition database in the voice recognition module and make judgments. The control key signals gained from comparison will be transmitted back to the game. Because the portable phone allows more kinds and larger number of games to be controlled through the aforesaid three ways, it will make the portable phone with easy operation interface applicable to different kinds of games for the purpose of improved operating applicability and convenience.

Another object of the present invention is to equally divide the screen picture of a computer into four quadrants and then sense the direction and acceleration of displacement of the portable phone by using the G sensor. Move the cursor to the center of the quadrant identified after the sensing signals are transferred to the computer for processing, comparison and judgment, and then the touch screen of the portable phone can be utilized to move the cursor. As the moving distance of the cursor reduces on the screen, users may move the cursor once to point to the target in the quadrant by moving the touch screen in a short distance, thus achieving the purpose of easy operation.

A further object of the present invention is to allow the computer to process the sensing signals and move the cursor to the center of a quadrant of the screen that displays comparison results following displacement of the portable phone, and then use the touch screen of the portable phone to control displacement of the cursor in the quadrant. As the moving distance of the cursor reduces, users may exercise control over movement of the cursor everywhere in the quadrants through the touch screen. Since it is not necessary to amplify signals for the touch screen, the minimum movable distance of the cursor will not increase. So the cursor can be adjusted finely to a desired position. Moreover, since the touch screen does not stop in the upward and downward directions when it moves in the oblique direction, users can move the cursor to a desired position by a single operation; thus improving smoothness and convenience in operation.

### BRIEF DESCRIPTION OF THE DRAWINGS

FIG. 1 is a block diagram according to one preferred embodiment of the present invention.

FIG. 2 is a flow chart of steps according to one preferred embodiment of the present invention (1).

FIG. 3 is a flow chart of steps according to one preferred embodiment of the present invention (2).

FIG. 4 is a flow chart of steps according to one preferred embodiment of the present invention (3).

FIG. 5 is a flow chart of steps according to one preferred embodiment of the present invention (4).

FIG. 6 is an appearance drawing illustrating divided quadrants of a display screen of a computer according to the present invention.

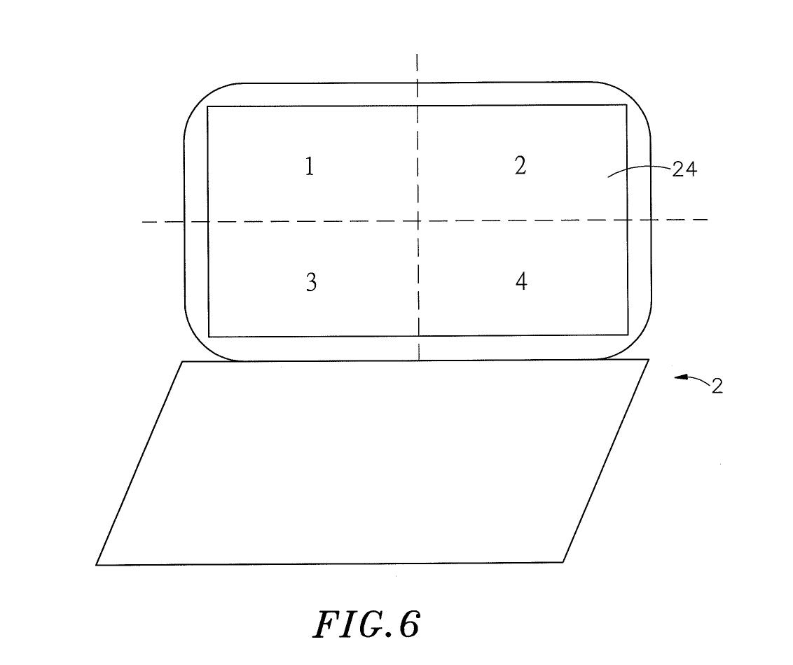

### DETAIL DESCRIPTION OF THE INVENTION

To achieve the aforesaid objects and functions as well as the techniques adopted in the present invention and its fabrication, an example of the preferred embodiment of the present invention is given to illustrate the features and functions of the present invention in detail by referring to the accompanying drawings.

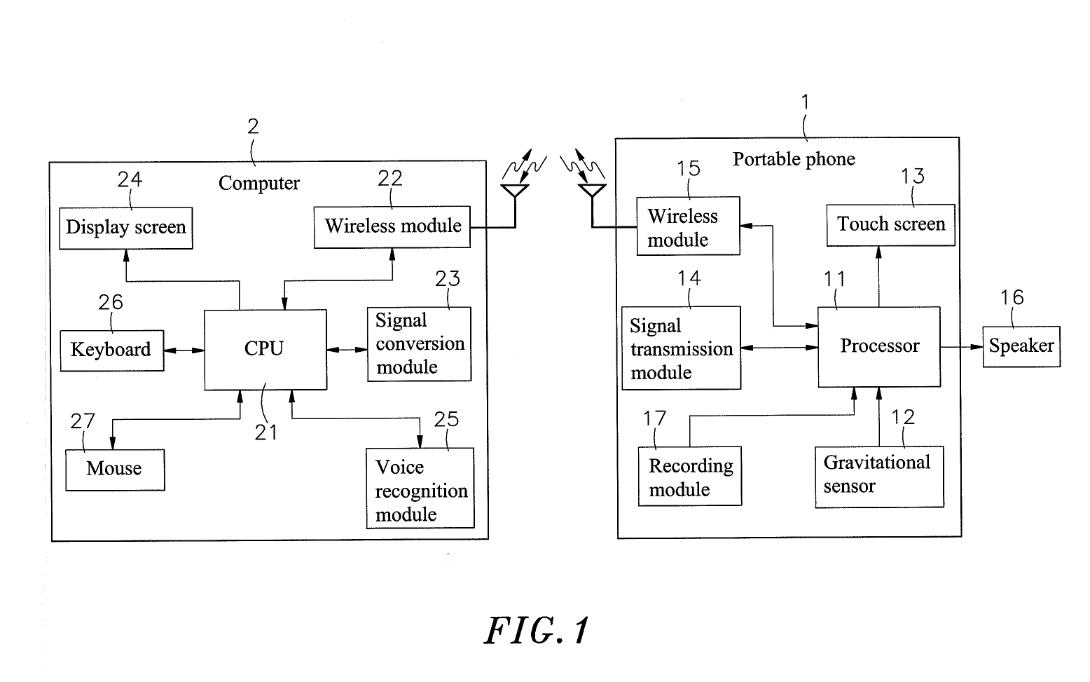

Refer to FIG. 1, which is a block diagram according to one preferred embodiment of the present invention. As shown clearly in this figure, the present invention comprises a portable phone 1 and a computer 2, wherein:

The portable phone 1 includes a central processing unit (CPU) 11, which is electrically connected with a G sensor 12 that can sense the direction and acceleration and a touch screen 13 that can sense touches and generate corresponding signals. In addition, the CPU 11 is electrically linked with a signal transmission module 14 that processes signals and a wireless module 15 that receives and transmits signals. Besides, the CPU 11 is also connected electrically with a speaker 16 which can make sounds and with a recording module 17 which can pick up ambient sounds. Then, the portable phone 1 can communicate by using the signal transmission module 14 and the wireless module 15 to transmit, receive and process signals and by using the speaker 16 and the recording module 17 to pick up and make sounds.

The computer 2 includes a central processing unit (CPU) 21, which is electrically connected with a wireless module 22 to receive and transmit signals and a signal conversion module 23 able to process and convert the signals it receives. And the CPU 21 is also connected electrically with a display screen 24, a voice recognition module 25 capable of identifying and comparing the voice data it picks up, a keyboard 26 and a mouse 27 for operating purpose.

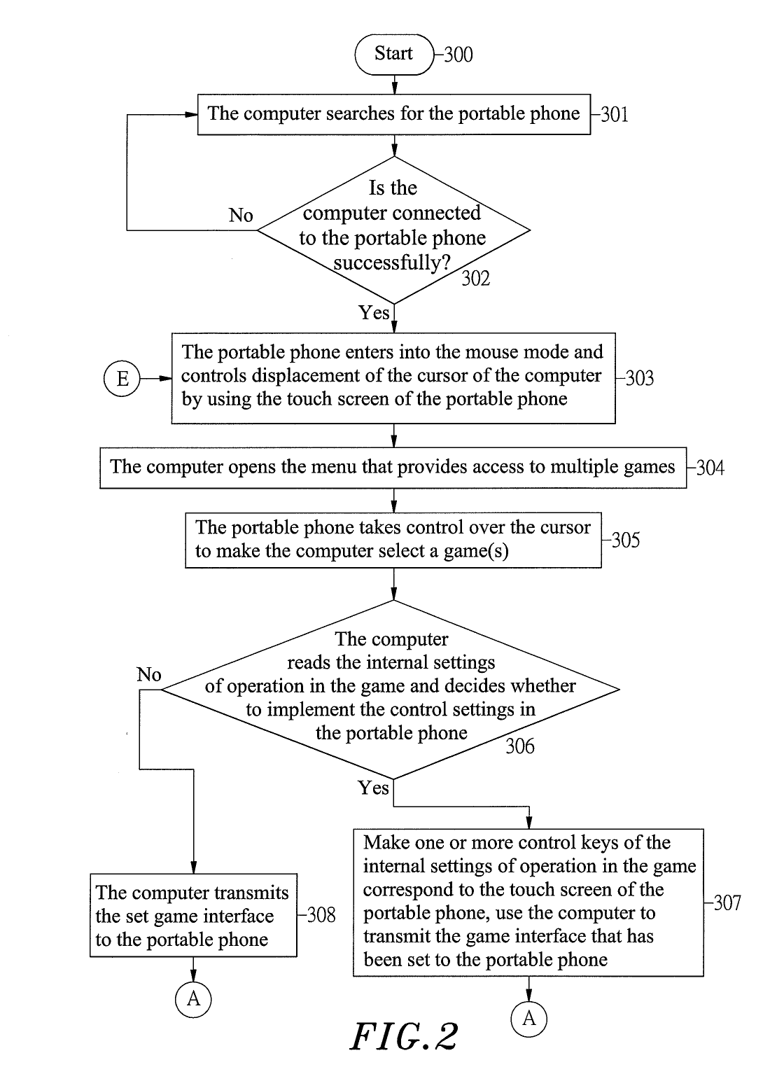

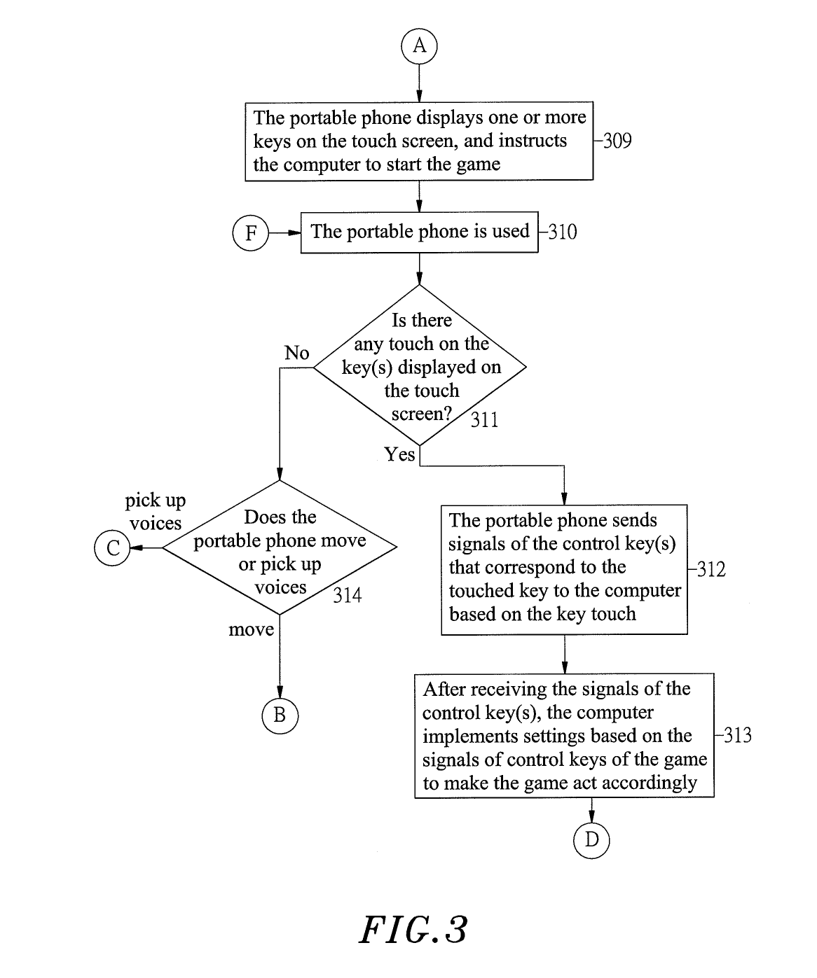

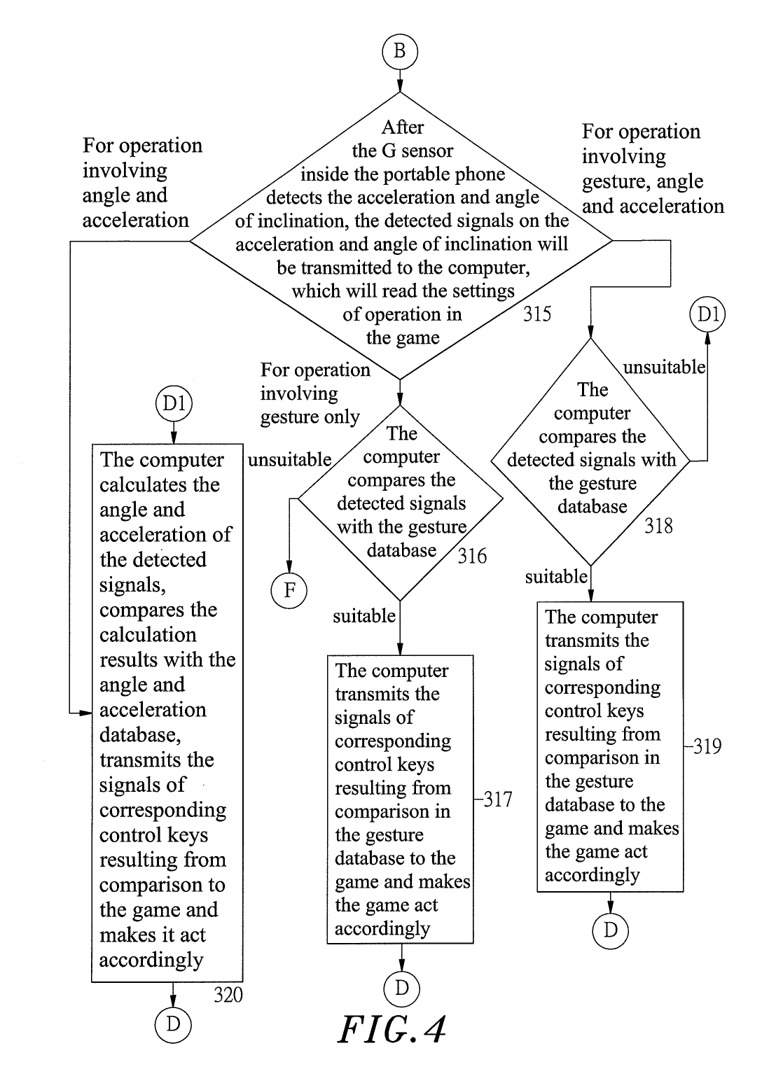

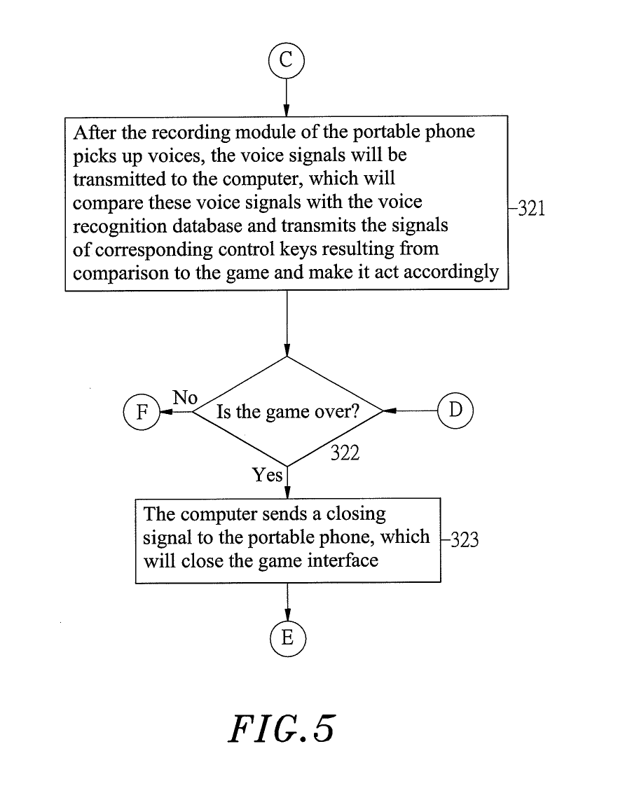

Refer to FIGS. 1-5, which are respectively a block diagram, a flow chart of steps (1), a flow chart of steps (2), a flow chart of steps (3) and a flow chart of steps (4) according to one preferred embodiment of the present invention. As shown clearly in these figures, the steps for the portable phone 1 to operate the computer 2 include:

(300) Start.

(301) The computer 2 searches for the portable phone 1.

(302) Whether the computer 2 is connected to the portable phone 1 successfully. If yes, proceed to step (303); if not, proceed to step (301).

(303) The portable phone 1 enters into the mouse mode and controls displacement of the cursor of the computer 2 by using the touch screen 13 of the portable phone 1.

(304) The computer 2 opens the menu that provides access to multiple games.

(305) The portable phone 1 takes control over the cursor to make the computer 2 select a game(s).

(306) The computer 2 reads the internal settings of operation in the game and decides whether to implement the control settings in the portable phone 1; if yes, proceed to step (307); if not, proceed to step (308)

(307) Make one or more control keys of the internal settings of operation in the game correspond to the touch screen 13 of the portable phone 1, use the computer 2 to transmit the game interface that has been set to the portable phone 1, and then proceed to step (309).

(308) The computer 2 transmits the set game interface to the portable phone 1.

(309) The portable phone 1 displays one or more keys on the touch screen 13, and instructs the computer 2 to start the game.

(310) The portable phone 1 is used.

(311) Is there any touch on the key(s) displayed on the touch screen 13? If yes, proceed to step (312); if not, proceed to step (314).

(312) The portable phone 1 sends signals of the control key(s) that correspond to the touched key to the computer 2 based on the key touch.

(313) After receiving the signals of the control key(s), the computer 2 implements settings based on the signals of control keys of the game to make the game act accordingly, and then proceed to step (322).

(314) Does the portable phone 1 move or pick up voices? If it moves, proceed to step (315); and if it picks up voices, proceed to step (321).

(315) After the G sensor 12 of the portable phone 1 detects the acceleration and angle of inclination, the detected signals on the acceleration and angle of inclination will be transmitted to the computer 2, which will read the settings of operation in the game. If operation involve gesture only, proceed to step (316), and if operation involve angle and acceleration, proceed to step (320), and if operation involve gesture, angle and acceleration, proceed to step (318).

(316) The computer 2 compares the detected signals with the gesture database; proceed to step (317) if they conform to each other, and if not, proceed to step (310).

(317) The computer 2 transmits the signals of corresponding control keys resulting from comparison in the gesture database to the game and make the game act accordingly, and then proceed to step (322).

(318) The computer 2 compares the detected signals with the gesture database; if they conform to each other, proceed to step (319); and if not, proceed to step (320).

(319) The computer 2 transmits the signals of corresponding control keys resulting from comparison in the gesture database to the game and make the game act accordingly, and then proceed to step (322).

(320) The computer 2 calculates the angle and acceleration of the detected signals, compares the calculation results with the angle and acceleration database, transmits the signals of corresponding control keys resulting from comparison to the game and make it act accordingly, and then proceed to step (322).

(321) After the recording module 17 of the portable phone 1 picks up voices, the voice signals will be transmitted to the computer 2, which will compare these voice signals with the voice recognition database and transmits the signals of corresponding control keys resulting from comparison to the game and make it act accordingly.

(322) Is the game over? If yes, proceed to step (323); if not, proceed to step (310).

(323) The computer 2 sends a closing signal to the portable phone 1, which will close the game interface, and proceed to step (303) again.

For applications, the portable phone 1 shall be connected with the computer 2 first to make the former enter into the mouse mode before users can directly use the portable phone 1 to operate the computer 2. Only in this way can users operate the cursor of the computer 2 on the touch screen 13 to enter into to the game menu successfully. The game menu may provide access to multiple preinstalled games or game links set by users. After a game is selected, since different games have different ways of operation and settings, users may, at their discretion, set control keys of the keyboard of the computer 2 to point to the touch screen 13 of the portable phone 1 and create a game interface to be transmitted to the portable phone 1, or directly transmits the preset game interface to the portable phone 1, so that one or more keys of the game interface can be displayed on the touch screen 13 of the portable phone 1.

When users touch keys on the touch screen 13, the portable phone 1 will send a signal of a control key on the keyboard of the computer 2 that corresponds to the touched key in accordance with the game interface. For example, if the control key of the keyboard originally set for the game is A, the portable phone 1 will send a signal indicating that the control key A is pressed to the computer 2. After having received the signal from the portable phone 1, the game in the computer 2 will execute an action(s) that corresponds to the situation where the control key A is pressed. The control keys of keyboard may be A, S, Z and Ctrl, etc. And this will help achieve the effect equivalent to pressing the keyboard to control over game actions. In addition, because data transmission between the portable phone 1 and the computer 2 is conducted wirelessly and the portable phone 1 is a widely-used electronic device, users do not need to pay additionally for game controllers.

Besides, there are too many types and forms of games, such as real-time strategy, action, Cosplay, shooting, flight and puzzle games, and different types of games require different ways of operation. In addition to displaying keys on the touch screen 13 through using the game interface, the portable phone 1 can use the G sensor 12 or recording module 17 for game control. In such cases, users need to move or wave the portable phone 1 to allow the G sensor 12 to sense the acceleration and angle of inclination, and then transmit these data to the computer 2. After reading the control settings for the game, the computer 2 will perform processing and calculations of the acceleration and angle of inclination based on the control settings and compare the results from processing and calculations with the angle-acceleration database and gesture database, and then send a signal of the corresponding control key to the game. For example, rotate leftwards or rightwards to represent the steering wheel in a racing game, incline back and forth or leftwards or rightwards for control over the horizontal plane in a balancing game, if the acceleration along a certain axis exceeds a set value, it represents striking with a cue in a pool game, exercise control over swing strength or putting in a golf game, control over forehand, forehand drive, forehand lob, backhand, backhand drive and backhand lob in a tennis game, race or skip in a track and field game, throw backwards or forwards in a throwing game, etc, for control over these games.

Since different games have different settings of control, if gestures are used for game control, the computer 2 will compare the data on the acceleration and angle of inclination sensed by the G sensor 12 with the gesture database. If the acceleration and angle are utilized for game control, the computer 2 will compare the data on the acceleration and angle that have been sensed with the angle-acceleration database. If gestures or acceleration and angle are available for game control, the computer 2 will compare the gestures with the gesture database at first, and only if they do not conform, the computer 2 will continue to compare the acceleration and angle with the angle-acceleration database. The purpose is to avoid the data on acceleration and angle from conforming to control settings in the gesture database and the angle-acceleration database simultaneously. Otherwise, two signals of control keys will be transmitted to the game at the same time, making it difficult for the game to determine which action shall be performed or cause the game to perform two actions instead of the one as users expect. Such situations will cause the game to be interrupted or finished, which will have serious impact on smoothness of game operation. By comparing with the complex gesture database at first and then with the simple angle-acceleration database, the signals of control keys that meet users' needs will be secured to ensure that this way of control leads to proper actions by the game.

Moreover, users can also speak to the portable phone 1, which will use the recording module 17 to pick up their voices and transmit the voice data to the computer 2. Following recognition of the voice data by using the voice recognition database, the computer 2 will transmit corresponding signals of control keys to the game for controlling purpose. For example, all kinds of missiles can be controlled by voices in airplane games, yell “come on” for spurting in track and field games. While there are much diversified game operations, e.g. cutting, rotating, racing, tilting, skipping, mapping, lining, shooting, selecting and many other types of action control, there is also difference in game control for different games. Besides, for some games, the number of control keys is relatively large (e.g. 10 keys, 23 keys, 37 keys, etc.). By using the keys on the touch screen 13, the G sensor 12 to sense movement and the recording module 17 to pick up voices, users will increase the number of keys of the portable phone 1 that can be replaced for game control, allowing the control method mentioned in the present invention to be applicable to games of different types. This will not only lead to increased operating applicability, but also achieve the purpose of easy and quick game control.

Furthermore, the G sensor 12 is often confronted with the issue of inaccurate sensing and cursor movement when sensing vertical displacement. Now that the portable phone 1 has the touch screen 13, if the computer 2 is equipped with the display screen 24 with touch functions, the cost will increase significantly. Considering popularity of the portable phone 1 in our life and low cost of the portable phone 1 equipped with the touch screen 13, the touch screen 13 of the portable phone 1 can be utilized to replace the mouse 27 and the display screen 24 with touch function and achieve the purposes of moving freely, multi-touch operation, reduced cost and accurate control.

Refer to FIGS. 1˜6, which are respectively a block diagram, a flow chart of steps (1), a flow chart of steps (2), a flow chart of steps (3) and a flow chart of steps (4) according to one preferred embodiment of the present invention as well as an appearance drawing illustrating divided quadrants of a display screen of a computer. As clearly shown in these figures, when the portable phone 1 and the computer 2 enter into the mouse mode, in addition to control over displacement of the cursor of the computer 2 through the touch screen 13 of the portable phone 1, the resolution of the display screen 24 can be equally divided to form the first, second, third and fourth quadrants. Users may first move the portable phone 1 (for example, by shaking or swinging), and the G sensor 12 inside the portable phone 1 will measure the acceleration and angle of inclination and send these data to the computer 2, which will process and calculate these data on acceleration and angle of inclination. The calculations involve the tri-axial accelerations X, Y and Z based on the formula \sqrt{x²+y²+z²}=t, wherein t>a preset value (e.g. 2, 3 or 4) indicates that actions of directing are generated, or multiple values of acceleration and angle of inclination continuously measured on the basis of time units are selected to compare with the continuous displacement shape preset in the database to decide the direction, for the purpose of avoiding slight or unintended movement that may lead to misjudgments. If t>a preset value, the computer 2 will decide which quadrant the cursor will point to and move the cursor to the center of that quadrant. For instance, swing the portable phone 1 in the bottom right direction, and the computer 2 will decide that the cursor will point to the fourth quadrant; then operate the cursor to make fine adjustments in position by using the touch screen 13 of the portable phone 1, or perform multi-touch operations (e.g. making relative adjustments by narrowing or widening the distance between two points). Since the cursor moves in a short distance, a single movement of the cursor may enable it to point to the target on that quadrant following movement of the touch screen 13 in a short distance.

In practical applications, the method for portable phones to control computers disclosed in the present invention have such advantages as follows:

(1) The portable phone 1 is characterized by low cost and has been widely used everywhere. Therefore, it can be used to operate the computer 2 for proper processing in order to achieve wireless game control and facilitate playing games through operation of the touch screen 13 without paying for the display screen 24 designed for the computer 2, thus reducing the cost.

(2) The portable phone 1 can display one or more keys of the game interface by using the touch screen 13, so that users can send signals of corresponding keys on the keyboard following touches and operation. It can use the G sensor 12 to sense movement of the portable phone 1, or use the recording module 17 to pick up voices, and instruct the computer 2 to transmit signals of corresponding control keys to the game after making a comparison with the angle-acceleration database, gesture database or voice recognition database of the voice recognition module 25. The aforesaid three methods will supplement the portable phone 1 with more alternatives for game control, and allow the portable phone 1 with easy operation interface to be applicable to different types of games.

(3) When the portable phone 1 and the computer 2 enter into the mouse mode, the computer 2 will equally divide the resolution of the display screen 24 to form the first, second, third and fourth quadrants. The portable phone 1 uses the G sensor 12 to sense the direction of displacement and acceleration, and sends these sensing signals to the computer 2, which will make judgments after processing and comparing these signals. Then, the computer 2 will move the cursor to the center of the identified quadrant, and use the touch screen 13 of the portable phone 1. Since the cursor moves in a short distance, a single movement of the cursor may enable it to point to the target on that quadrant following movement of the touch screen 13 in a short distance.

(4) After the portable phone 1 move, the signals processed by the computer 2 will drive the cursor to move to the center of the identified quadrant of the display screen 24 which has been equally divided into four quadrants, and the touch screen 13 of the portable phone 1 is used to move the cursor. Since it is not necessary to amplify signals for the touch screen 13 of the portable phone 1, the minimum movable distance of the cursor will not increase. So the cursor can be adjusted finely to a desired position. This not only enables users to move the cursor to a desired position by a single operation, and solve the problem that the G sensor 12 cannot accurately move upwards and downwards when it moves in the oblique direction.

So the present invention mainly deals with the method for portable phones to control computers, in which the touch screen 13 of the portable phone 1 displays one or more keys of the game interface, the G sensor 12 senses movement of the portable phone 1, or the recording module 17 is used to pick up voices, so that the portable phone 1 can control the computer 2 to perform game operations, achieving the advantage of the low-cost portable phone 1 in controlling the computer 2 wirelessly through touches. However, the above descriptions are given to illustrate one example of the preferred embodiments of the present invention, and shall not be construed as limitations on the scope of the appended claims of the present invention. It is hereby declared that all modifications and equivalent structural changes made in accordance with the descriptions and drawings disclosed in the present invention shall be included in the patent claims of the present invention.

To sum up, the method for portable phones to control computers of the present invention as described above can really achieve its functions and objects. Therefore, the present invention is really an excellent one with practical applicability, and can satisfy the conditions for patentability of a utility model. While the application of patent is filed pursuant to applicable laws, your early approval of the present invention will be highly appreciated so as to guarantee benefits and rights of the inventor who has worked hard at this invention.

What the invention claimed is:

1. A method for portable phones to control computers, more particularly, the method in which a portable phone that includes a gravitational sensor (G sensor), a touch screen and a recording module is used for movement and touches to control a computer and its display screen to perform operations as expected, comprising the following steps:
(A) start;
(B) the computer searches for the portable phone;
(C) whether the computer is connected to the portable phone successfully? If yes, proceed to step (D); if not, proceed to step (B);
(D) the portable phone enters into the mouse mode and controls displacement of the cursor of the computer by using the touch screen of the portable phone;
(E) the computer opens the menu that provides access to multiple games;
(F) the portable phone takes control over the cursor to make the computer select a game(s);
(G) the computer transmits the set game interface to the portable phone;
(H) the portable phone displays one or more keys on the touch screen, and instructs the computer to start the game;
(I) the portable phone is used;
(J) is there any touch on the key(s) displayed on the touch screen? If yes, proceed to step (K); if not, proceed to step (M);
(K) the portable phone sends signals of the control key(s) that correspond to the touched key to the computer based on the key touch;
(L) after receiving the signals of the control key(s), the computer implements settings based on the signals of control keys of the game to make the game act accordingly, and then proceed to step (S);
(M) does the portable phone move or pick up voices? If it moves, proceed to step
(N); and if it picks up voices, proceed to step (R); (N) the computer reads the settings of operation in the game. For operation involving gesture only, proceed to step (O); and for operation involving angle and acceleration, proceed to step (Q);
(O) the computer compares the detected signals with the gesture database; proceed to step (P) if they conform to each other, and if not, proceed to step (I);
(P) the computer transmits the signals of corresponding control keys resulting from comparison in the gesture database to the game and make the game act accordingly, and then proceed to step (S);
(Q) the computer calculates the angle and acceleration, compares the calculation results with the angle-acceleration database, transmits the signals of corresponding control keys resulting from comparison to the game and make it act accordingly, and then proceed to step (S);
(R) after the recording module of the portable phone picks up voices, the voice signals will be transmitted to the computer, which will compare these voice signals with the voice recognition database and transmits the signals of corresponding control keys resulting from comparison to the game and make it act accordingly, then proceed to step (S);
(S) is the game over? If yes, proceed to step (T); if not, proceed to step (I);
(T) the computer sends a closing signal to the portable phone, which will close the game interface, and proceed to step (D) again.

2. The method for portable phones to control computers according to claim 1, wherein the portable phone controls the cursor to allow the computer to select a game; the computer reads the internal settings of operation, and decides whether there is the need to conduct control settings for the portable phone; if yes, make one or more control keys set for the internal game control correspond to the touch screen of the portable phone, use the computer to transmit the set game interface to the portable phone, and then make the portable phone display one more keys on the touch screen; if not, the computer will transmit the set game interface to the portable phone, so that the portable phone can display one or more keys on the touch screen.

3. The method for portable phones to control computers according to claim 1, wherein the computer generates the first, second, third and fourth quadrants of the display screen by dividing the resolution equally; when users moves the portable phone in an oblique direction, the G sensor inside the portable phone will sense the acceleration and angle of inclination, and transmit the sensing signals of acceleration and angle of inclination to the computer via a central processing unit (CPU), a signal transmission module and a wireless module; the CPU of the computer will process and compare the data on acceleration and angle of inclination, and decide whether it is larger than a preset value; if yes, the computer will decide which quadrant is targeted according to the angle of inclination, and then move the cursor to the center of the quadrant; in such cases, users operate to move on the touch screen of the portable phone, and the touch screen will transmit touch signals to the computer through the CPU, signal transmission module and wireless module after sensing the touch signals, so that the computer can move the cursor to the right place in the quadrant based on coordinates of the touch signals; if not, no handling is needed, and users may move the portable phone towards an oblique direction.

4. The method for portable phones to control computers according to claim 1, wherein the computer reads the preset control settings of the game; for control through gesture, angle and acceleration, the computer will compare the sensing signals with the gesture database, and in case of conformity, will send the signals of control keys resulting from comparison with the gesture database to the game, so that the game can act accordingly and then proceed to step (S); otherwise, proceed to step (Q).
